(19) United States
(12) Patent Application Publication
(10) Pub. No.: US 2025/0137351 A1
(43) Pub. Date: May 1, 2025

(54) BurstGuard Check Valve

(71) Applicant: Peak Completion Technologies, Inc., Midland, TX (US)

(72) Inventors: Kevin Rogers, Midland, TX (US); Reed Goodman, Midland, TX (US); William Muscroft, Midland, TX (US); Norm Scholes, Midland, TX (US)

(21) Appl. No.: 18/932,181

(22) Filed: Oct. 30, 2024

Related U.S. Application Data
(60) Provisional application No. 63/594,092, filed on Oct. 30, 2023.

(51) Int. Cl. E21B 34/06; F16K 17/40

(52) U.S. Cl. CPC E21B 34/063; F16K 17/403

(57) ABSTRACT

A check valve for use with a gas lift system containing a burst disc. The burst disc, when whole, prevents gas from flowing between the mandrel and the tubing. The burst disc is designed to burst when the operator applies a specific amount of pressure to the burst disc. Once ruptured, the burst disc no longer prevents gas from flowing from the mandrel un into the tubing.

### CROSS-REFERENCES TO RELATED APPLICATIONS

This application claims the priority date of U.S. provisional application No. 63/594,092, filed Oct. 30, 2023, the contents of which are incorporated by reference herein.

### STATEMENT REGARDING FEDERALLY SPONSORED RESEARCH OR DEVELOPMENT

Not applicable.

### BACKGROUND OF THE INVENTION

### 1. Field of the Invention

Gas lift systems are integral to the optimization of oil and gas production by aiding in the artificial lift of reservoir fluids. Generally speaking, gas lift systems use an external source of gas to inject gas into a formation via a tubing. The gas injected into the tubing reduces the density of the fluids in the tubing and creates bubbles which have a scrubbing action on the liquids in the tubing. The combined effect is that the injected gas increases the lift of the gas out of the formation.

A check valve is a fundamental part of a gas lift system. In the context of gas lift, a check valve is responsible for allowing the injected gas to flow into the wellbore while preventing the backflow of fluids from the well into the gas lift system. This helps maintain the integrity and effectiveness of the gas lift operation.

A burst disc, or rupture disc, is a disc made up material designed to rupture. Burst discs have been used as a non-reclosing pressure relief device that protects systems or equipment from over pressurization. Historically, pressure isolation devices such as burst disc have been installed above and below the gas lift mandrel to ensure pressure isolation. Historically, there has been a need in the industry to protect and promote the lifespan of the gas lift check valve.

### SUMMARY OF THE INVENTION

Applicant's burst guard check valve functions to prevent flow of fluid through a gas lift system until such time that it is desired for gas to pass through the system. Applicant's burst guard check valve comprises a rupture disc that isolates flow from an annulus to a tubing and subsequently from a tubing to an annulus. At such time that fluid flow is desired across the gas lift system, pressure is applied from the tubing side to rupture the disc which allows flow as desired from annulus to tubing. Upon rupture the burst guard check valve allows full passage of gas, leaving no restriction in the flow path. Once the burst guard check valve is ruptured, gas lift operations can commence in their normal operation without hinderance.

This burst guard check valve is essential for reducing downtime and capital expenditures with gas lift conversion applications because the burst guard check valve allows operators to convert from a high pressure gas lift to a conventional gas lift without pulling tubing via a workover. The integration of burst discs within gas lift check valves represents a pioneering advancement in the field.

Burst discs act as pressure relief mechanisms, safeguarding the gas lift system and associated infrastructure from overpressure events. By preventing engagement of conventional gas lift systems during high pressure gas lift applications, burst disc-equipped gas lift check valves contribute to maintaining conventional valve integrity until such time the operator chooses to convert to traditional gas lift. Gas lift check valves with burst discs represent an indispensable innovation within the Gas Lift sector. The ability to regulate gas flow, prevent backflow, and protect against overpressure events underscores their importance in optimizing production and ensuring safety in the dynamic and challenging environment of oil and gas production operations.

In other embodiments, the check valve comprises a degradable and/or dissolvable plug in line with the gas lift equipment check valves. Dissolvable and degradable plugs can be used as a non-reclosing pressure relief device component that protect systems or equipment from pressurization in predetermined pressure differential.

### BRIEF SUMMARY OF THE DRAWINGS

FIG. 1 is a perspective view of an embodiment of the burst guard check valve.

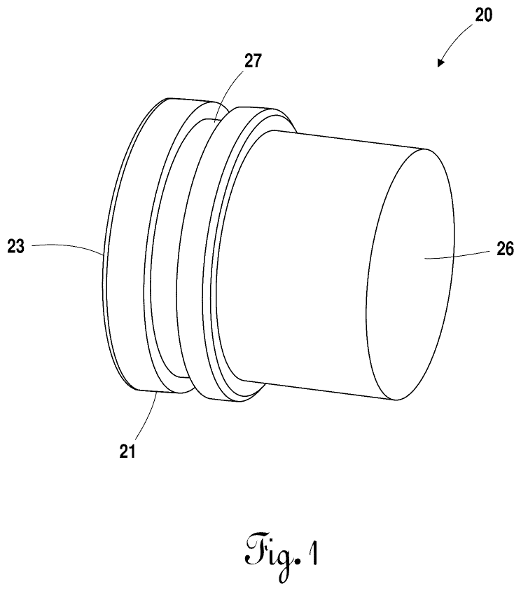

FIG. 2 is a side view of an embodiment of the burst guard check valve.

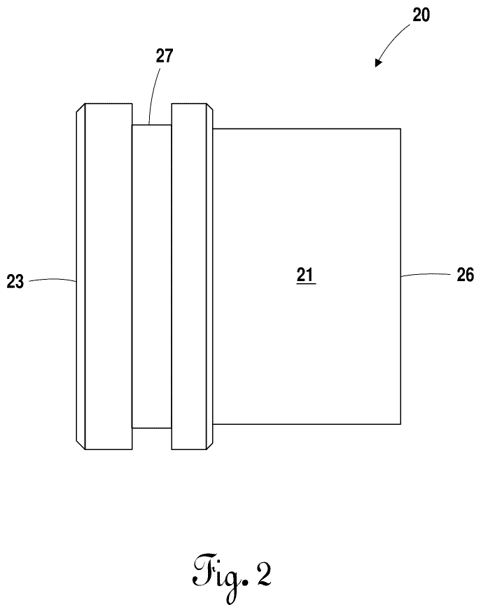

FIG. 3 is a cut away view of an embodiment of the burst guard check valve.

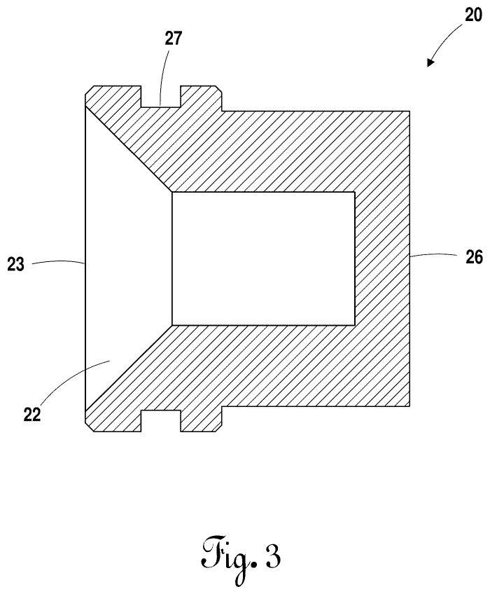

### DETAILED DESCRIPTION

The burst guard check valve 20 comprises a main housing 21. The main housing 21 will typically be made of durable materials such as stainless steel or corrosion-resistant alloys. The main housing 21 contains the internal components and connections for the gas lift burst guard check valve system. An integrated burst disc 22 is a critical mechanical feature of the bust guard. The burst disc 22 is a circular disc made from a material designed to rupture at a predetermined pressure. The burst disc 22 acts as a fail-safe mechanism to release excess pressure in the system, preventing potential overpressurization and damage to the gas lift valve and check. The burst guard check valve 20 may also include an o-ring notch 27.

An inlet port 23 of the burst guard check will be connected to the bottom of a check and an outlet port 26 will be connected to a mandrel. Prior to the disc 22 rupturing, the disc 22 prevents fluid and/or gas from moving between the check and the mandrel. Once the disc 22 is ruptured, the disc 22 no longer prevents fluid or gas from passing through the inlet 23 through the outlet 26 and into a tubing via the mandrel.

The best mode of implementation would be to choose high quality materials when manufacturing that are resistant to corrosion and suitable for the harsh conditions encountered in the wellbore for oil and gas operations. The burst disc 22 can be engineered to rupture at a specific pressure by choosing desired material and thickness for the disc 22.

The burst guard check valve 20 is installed ensuring the integrated burst disc 22 portion is connected to the gas lift mandrel. The check valve portion will then be connected to the burst disc portion 22. The gas lift valve will then be connected to the check valve portion

In another embodiment, a check valve comprises a degradable and/or dissolvable plug. The check valve with degradable and/or dissolvable plug prevents flow through the gas lift system until such time the plug dissolves or degrades to allow for gas passage through the gas lift valve and check valve. The plug is comprised of dissolvable plastic materials or metallic alloys including, but not limited to, composites comprised of various amounts of magnesium, aluminum, gallium or biodegradable polymers that isolates flow from annulus to tubing and subsequently from tubing to annulus. These materials may include, but are not limited to, polyglycolic acid (PGA), polyglycolide, polylactic acid (PLA), polylactic-co-glycolic acid (PLGA), polyhydroxyalkanoates (PHA) such as polyhydroxybutyrate (PHB) and polyhydroxyvalerate (PHV), magnesium alloys such as magnesium-aluminum and magnesium-zinc, polycaprolactone (PCL), and polybutylene succinate (PBS). The selection of material is dependent on specific operational conditions including well salinity, temperature, pressure, and the expected dissolution of the customer given the previous three attributes.

Once the plug dissolves or degrades, full passage of gas is available while leaving no restriction in the flow path and gas lift operations can commence in their normal operation without hinderance. The primary function of the degrading material is to possess acceptable mechanical properties for a controlled period while degrading in the presence of fluids, gasses, temperatures, or a combination of all three at the end of which the material is no longer present or no longer possesses mechanical properties to inhibit the operation of the gas-lift system.

The main housing of a dissolvable plug will be made of dissolvable materials such as metallic alloys. The body contains the internal components and connections for the gas lift system. The integrated dissolvable and/or degradable plug is a critical mechanical feature. The dissolvable and/or degradable component is a centralized integrated plug made from material designed to dissolve or degrade at times dependent on well salinity, temperature and pressure. For example, in high salinity environments, certain magnesium alloys may dissolve more rapidly due to increased ionic activity, while in lower salinity environments, the dissolution rate might be slower. Temperature also plays a crucial role; higher temperatures can accelerate the dissolution process of polyglycolic acid (PGA) and its derivatives, whereas lower temperatures might slow it down. Pressure conditions are equally important as they affect the mechanical stability and integrity of the materials; higher pressures may necessitate the use of materials with higher tensile strength to ensure they remain intact until the desired dissolution time. Additionally, pH levels can influence the rate at which biodegradable polyesters dissolve, with more acidic or alkaline conditions potentially speeding up the degradation process. The integrated dissolvable plug acts as a fail-safe mechanism to isolate pressure and flow from tubing acting on the check valve, preventing potential early degradation and damage to the gas lift valve and check. The inlet port of the will be connected to the bottom of the check and outlet port will be connected to the mandrel. Once the plug is dissolved or degraded, it will allow for gas passage from the inlet through the outlet and into the tubing via the mandrel.

The best mode of implementation would be to choose high quality materials when manufacturing that are resistant to corrosion and suitable for the harsh conditions encountered in the wellbore for Oil and Gas operations. The dissolvable and/or degradable plug should be carefully engineered to dissolve at estimated times based on specific pressure, salinity and temperature. The integrated dissolvable plug material and thickness must be selected accordingly. Ensure proper installation of the check valve with plug pressure isolation device by ensuring the integrated degradable plug portion is connected to the gas lift mandrel first. The check valve portion will then be connected to the degradable plug component. The gas lift valve will then be connected to the check valve portion.

Dissolvable plugs act as pressure isolation mechanisms, safeguarding the gas lift system. By preventing engagement of conventional gas lift systems during high pressure gas lift applications, integrated dissolvable plug-equipped gas lift check valves contribute to maintaining conventional valve integrity until dissolution. This ultimately protects the check valve and valve components to promote longevity and integrity of the gas lift system post installation. In conclusion, gas lift check valves with integrated dissolvable plugs represent an indispensable innovation within the Gas Lift sector. Their ability to regulate gas flow, prevent backflow, and protect against overpressure events underscores their importance in optimizing production and ensuring safety in the dynamic and challenging environment of oil and gas production operations.

I claim:

1. A check valve comprising:
a housing and a burst disc;
wherein the check valve is configured to prevent fluid from passing through the check valve when the burst disc is in an unruptured state;
wherein the burst disc is configured to burst upon the application of a pre-set amount of pressure to the burst disc;
wherein the check valve is configured to allow fluid to pass through the check valve when the burst disc is in the ruptured state.

2. The check valve of claim 1 wherein the fluid is gas.

3. A method of providing artificial gas lift comprising:
determining an amount of pressure that will cause a burst disc to rupture;
integrating a burst disc configured to rupture at the determined amount of pressure into a check valve wherein the burst disc is initially in an unruptured state;
wherein the check valve prevents the flow of fluid through the check valve when the burst disc is in an unruptured state;
rupturing the burst disc by applying the determined amount of pressure that will cause the burst disc to rupture to the burst disc;
wherein the check valve allows fluid to flow through the check valve when the burst disc is in a ruptured state.

4. The method of claim 3 wherein the fluid is gas.
